(19) United States
(12) Patent Application Publication
(10) Pub. No.: US 2013/0246510 A1
(43) Pub. Date: Sep. 19, 2013

(54) REMOTE CONTROL SYSTEM, CLIENT DEVICE, AND SERVER DEVICE

(71) Applicants: Hidemitsu SHIMAMOTO, Tokyo (JP); Kenji TSUNASHIMA, Tokyo (JP)

(72) Inventors: Hidemitsu SHIMAMOTO, Tokyo (JP); Kenji TSUNASHIMA, Tokyo (JP)

(73) Assignee: Mitsubishi Electric Corporation, Tokyo (JP)

(21) Appl. No.: 13/801,067

(22) Filed: Mar. 13, 2013

(30) Foreign Application Priority Data
Mar. 14, 2012 (JP) 2012-057053
Jan. 16, 2013 (JP) 2013-005396

(51) Int. Cl. H04L 29/06

(52) U.S. Cl. CPC H04L 65/602
USPC 709/203

(57) ABSTRACT

A remote control system including a server device and a client device. The client device displays an operation screen of the server device and, when an operation is input, sends operation information to the server device, thereby remotely operating the server device. The client device may request a moving picture content file from the server device. Upon receiving the requested moving picture content file, the client device displays the moving picture in place of the operation screen. The user of the client device can then view the moving picture without being troubled by the slow screen update speed of the remote control operation screen.

### BACKGROUND OF THE INVENTION

1. Field of the Invention

This invention relates to a remote control system, a client device, and a server device.

2. Description of the Related Art

Remote control techniques for operating a remote computer from a computer close at hand are widely employed. In VNC (Virtual Network Computing), for example, remote control is implemented by sending a server device's image information to a client device by use of the RFB (Remote Frame Buffer) protocol, displaying the image information on a display screen at the client device, and sending mouse or keyboard operation information from the client device to the server device to control the server device. VNC can run on a variety of computer platforms. Another example is the remote desktop that runs on Windows (a registered trademark), which operates by using RDP (Remote Desktop Protocol). Audio signals are not transmitted in either of these protocols.

A problem encountered in these remote control techniques is slow updating of the remote control screen at the client device, because of the need to send large quantities of image information from the server device to the client device. In a technique described by Nishino in Japanese Patent Application Publication No. 8-297617, instead of sending image data, the server device extracts and sends drawing commands, which the client device executes. In a technique described by Takara et al. in Japanese Patent Application Publication No. 2004-086550, the image data in rectangular areas in two frames are checked, and only the image data in areas that have been updated are sent, in a compressed form.

Nishino's technique, however, cannot be applied to moving pictures, and the technique taught by Takara et al. is unsuitable for moving picture transmission because of the heavy processing load.

In a remote control system in which a television receiver (a TV set) is used as the client device and a computer is used as the server, the computer's rich store of application software and downloaded content files becomes accessible from the TV set. Since a TV set is normally used to view and listen to moving pictures with audio, including broadcast content, digital versatile disc (DVD) content, and other such content, it would be more convenient for the viewer in the remote control system if the viewer could view moving picture content stored in the computer in the familiar way.

### SUMMARY OF THE INVENTION

An object of the present invention is to enable the user to view moving picture content by remote control without being troubled by slow screen update speed.

The invention provides a remote control system including a client device and a server device.

The client device has a first interface unit connected to a network, an input unit for input of user operations, a display unit for displaying an image on a screen, a remote client unit for receiving an image signal representing an operation screen of the server device from the server device through the first interface unit, and sending the server device operation information indicating input operations performed on the input unit pursuant to display of the operation screen of the server device on the display unit, an event detection unit for detecting input of a predetermined operation on the input unit, a client control unit for sending the server device a predetermined notification through the first interface unit when the event detection unit detects the input of the predetermined operation, a stream receiving unit for separating a video bitstream signal from a content file received from the server device through the first interface unit, a decoder for decoding the video bitstream signal to generate an image signal of a moving picture, and a display control unit for receiving an image signal representing the operation screen from the remote client unit and causing the display unit to display the operation screen, and for receiving the image signal of the moving picture from the decoder and causing the display unit to display the moving picture in place of the operation screen.

The server device has a second interface unit connected to the network, a remote server unit for receiving the operation information through the second interface unit and sending the client device, through the second interface unit, an image signal representing an operation screen indicating a result of processing performed by the server device in response to the operation indicated by the operation information, a content storage unit for storing content files, and a processing unit for receiving the predetermined notification through the second interface unit and thereupon, when the predetermined operation selects a content file stored in the content storage unit and the selected content file is a moving picture content file, sending the content file through the second interface unit to the client device.

In one aspect, the invention enables the user to view moving picture content by remote control without being troubled by slow screen update speed.

### BRIEF DESCRIPTION OF THE DRAWINGS

In the attached drawings:

FIG. 1 is a block diagram schematically depicting the structure of a remote control system according to first and second embodiments of the invention;

FIG. 2 is a block diagram schematically depicting the structure of the server device in the first and second embodiments;

FIG. 3 is a block diagram schematically depicting the structure of the client device in the first embodiment;

FIG. 4 is a diagram illustrating the sequence of processing in the remote control system in the first embodiment;

FIG. 5 is a flowchart showing an example of the operation of the client control unit in the first embodiment;

FIG. 6 is a block diagram schematically depicting the structure of the client device in the second embodiment;

FIG. 7 is a diagram illustrating the sequence of processing in the remote control system in the second embodiment; and

FIG. 8 is a flowchart showing an example of the operation of the client control unit in the second embodiment.

### DETAILED DESCRIPTION OF THE INVENTION

Embodiments of the invention will now be described with reference to the attached drawings, in which like elements are indicated by identical or similar reference characters.

### First Embodiment

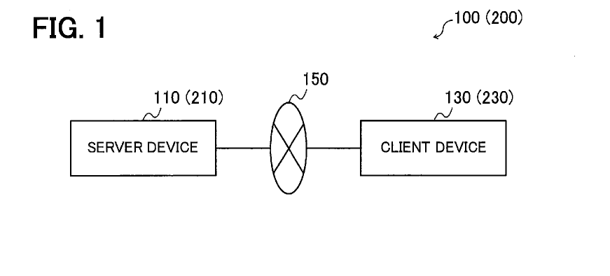

Referring to FIG. 1, the remote control system 100 in the first embodiment includes a server device 110 and a client device 130. The server device 110 and the client device 130 are interconnected by a network 150. The server device 110 is the remotely controlled device. The server device 110 may be, for example, a personal computer. The client device 130 is, for example, a TV set that remotely controls the server device 110.

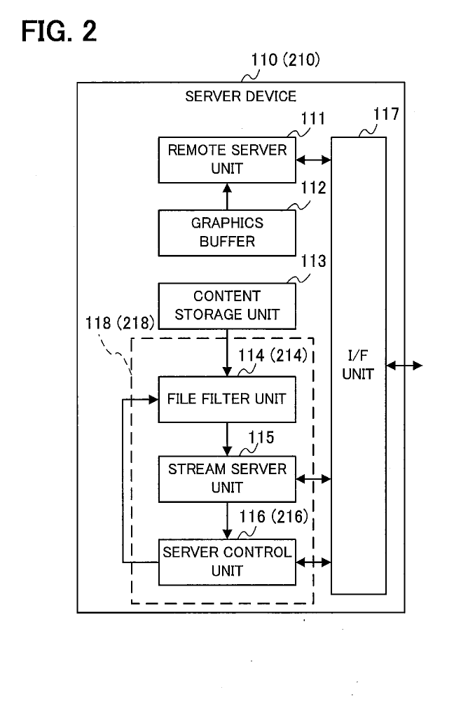

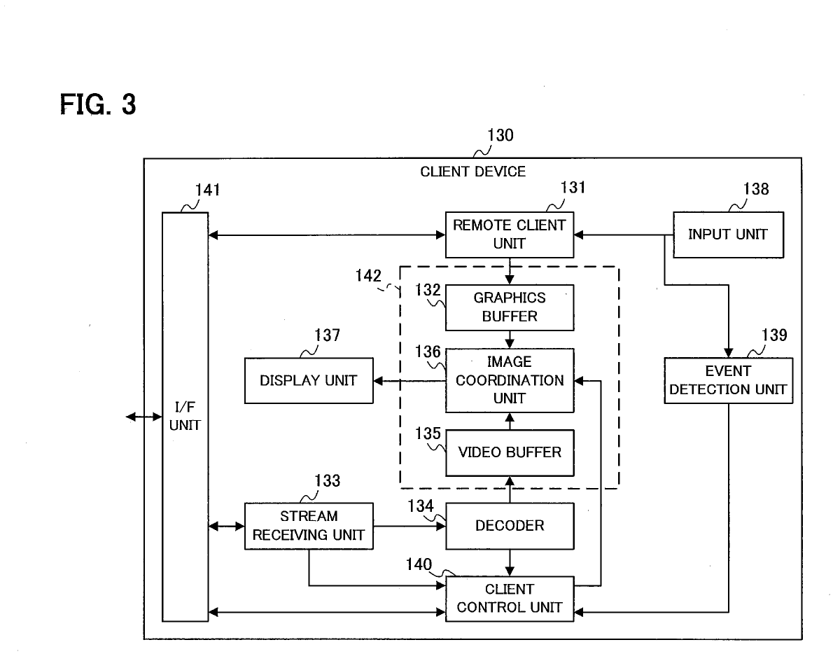

The structure of the server device 110 is schematically shown in FIG. 2. The structure of the client device 130 is schematically shown in FIG. 3. The reference numerals shown in parentheses in FIGS. 1 and 2 will be used in the second embodiment.

Referring to FIG. 2, the server device 110 includes a remote server unit 111, a graphics buffer 112, a content storage unit 113, a file filter 114, a stream server unit 115, a server control unit 116, and an interface (I/F) unit 117. The file filter 114, stream server unit 115, and server control unit 116 form a processing unit 118.

Referring to FIG. 3, the client device 130 includes a remote client unit 131, a graphics buffer 132, a stream receiving unit 133, a decoder 134, a video buffer 135, an image coordination unit 136, a display unit 137, an input unit 138, an event detection unit 139, a client control unit 140, and an interface unit 141. The graphics buffer 132, video buffer 135, and image coordination unit 136 form a display control unit 142.

In the server device 110 shown in FIG. 2, the remote server unit 111 performs necessary processing in response to remote control applied by the remote client unit 131 in the client device 130 through the interface unit 117. For example, the remote server unit 111 receives event information from the client device 130 through the interface unit 117 and notifies the server control unit 116 of the operation indicated by the event information. The server control unit 116 performs processing corresponding to the operation, and the remote server unit 111 sends the client device 130, through the interface unit 117, the image signal of an operation screen, more specifically a desktop image, indicating the result of the processing performed by the server control unit 116.

Incidentally, although the following description will refer to desktop images, it will be appreciated that a desktop image is only one possible type of operation screen, and that the invention is applicable to other types of operation screens as well.

It will be assumed below that the remote server unit 111 in the server device 110 and the remote client unit 131 in the client device 130 are compliant with a form of VNC. This embodiment is not limited to any specific form of VNC, however, and the invention need not use VNC at all. The remote server unit 111 uses, for example, the Transmission Control Protocol/Internet Protocol (TCP/IP) for communication with the remote client unit 131.

The graphics buffer 112 stores the desktop image of the server device 110. The desktop image stored in the graphics buffer 112 is updated by the server control unit 116, for example. The remote server unit 111 then sends an image signal of the updated portion of the desktop image through the interface unit 117 to the remote client unit 131. For example, the remote server unit 111 may send the pixel data of a comparatively small rectangular area in the desktop image, in an encoded form.

The content storage unit 113 stores content files held in the server device 110. Included among the content files there may be document files, spreadsheet files, image files, audio files, moving picture files, and so on.

When an inspection command is supplied from the server control unit 116, the file filter 114 inspects a user-selected content file to determine whether it satisfies predetermined conditions. That is, the file filter 114 screens content files and supplies only content files satisfying the predetermined conditions to the stream server unit 115. For example, the file filter 114 may supply a user-selected content file to the stream server unit 115 if the content file is a moving picture file having an image size equal to or greater than a predetermined image size.

As a user-selected content file is not necessarily a moving picture file, the file filter 114 detects a kind of the user-selected content file. The file filter 114 may first test user-selected content files by, for example, inspecting the extension of their file names and screens out the user-selected content files that have extensions of a document file, a spreadsheet file, a still image file, or any other file irrelevant to a moving picture. The file filter 114 screens out files having extensions such as .txt, .doc, .xls, or .jpg, indicating a document file, a spreadsheet file, a still image file, or any other file irrelevant to a moving picture. The file filter 114 also inspects the structure of the content file and selects only binary files. The file filter 114 further inspects the data in the content file and selects only files having particular bitstream header information. The file filter 114 then inspects the bitstream header information to determine the image size of the moving picture file and selects the file if it has an image size equal to or greater than the predetermined size. The file filter 114 supplies content files selected in this way to the stream server unit 115.

The stream server unit 115 sends content files supplied from the file filter 114 to the client device 130 through the interface unit 117. The stream server unit 115 uses, for example, the User Datagram Protocol/Internet Protocol (UDP/IP), which can send data steadily and is suited for real-time transmission, rather than TCP/IP, which includes retransmission operations. Alternatively, the stream server unit 115 may use another communication protocol such as the Hypertext Transfer Protocol (HTTP) for content file transmission. Since the remote server unit 111 and the content storage unit 113 have already started remote control operations, their IP addresses are already known.

The server control unit 116 controls all processing performed in the server device 110. For example, the server control unit 116 controls communication by the remote server unit 111 and the stream server unit 115, processing of input events, and content file transmission. When a predetermined notification, more particularly a file request, is received from the client device 130 through the interface unit 117, the server control unit 116 gives the file filter 114 an inspection command to have the content file selected by the user examined and screened. For example, if the server control unit 116 has accessed a content file stored in the content storage unit 113 in accordance with event information received from the remote server unit 111 during a given period of time before and after the time at which the file request is received, the server control unit 116 gives the file filter 114 an inspection command containing the information indicating the accessed content file. If the server control unit 116 has accessed no content file stored in the content storage unit 113 in accordance with event information received from the remote server unit 111 during the given period of time before and after the time at which the file request is received, the server control unit 116 ends the process without giving the file filter 114 an inspection command. The server control unit 116 controls the stream server unit 115 to have it send content files that have passed screening by the file filter 114 to the client device 130. If the user does not select a content file, if the user-selected content file is not a moving picture file, or if the content file has an image size smaller than the predetermined image size, the server control unit 116 may notify the client control unit 140 of the client device 130 through the interface unit 117 that it has cancelled the file transmission.

When the processing unit 118 receives a file request from the client device 130, if three conditions are satisfied, the processing unit 118 sends the content file selected by the user through the interface unit 117 to the client device 130. The first of the three conditions is that the user selects a content file recorded in the content storage unit 113. The second of the three conditions is that the selected content file is a moving picture file. The third of the three conditions is that the image size of the selected content file is equal to or greater than a predetermined size. Incidentally, the condition requiring the image size of the selected content file to be equal to or greater than a predetermined size may be removed from the set of necessary conditions.

The interface unit 117 is connected to the network 150 and functions as a second interface for sending and receiving data.

The client device 130 will now be described with reference to FIG. 3.

The remote client unit 131 receives an image signal representing the desktop image of the server device 110 through the interface unit 141. The remote client unit 131 has the graphics buffer 132 store the received image signal. For example, the remote client unit 131 may reproduce the server's desktop image by writing pixel data received through the interface unit 141 on the graphics buffer 132. In accordance with event input from the input unit 138, the remote client unit 131 also generates event information indicating a key event or pointer event, and sends the generated event information through the interface unit 141 to the server device 110.

The graphics buffer 132 stores the image signal representing the desktop image supplied from the remote client unit 131. When the remote client unit 131 is not performing remote control of the server device 110, the graphics buffer 132 may store the image signal of a display image supplied from the client control unit 140. This display image may be an image needed for control of the client device 130 itself, such as a setup display image for making various settings.

The stream receiving unit 133 receives content file through the interface unit 141 and separates video bitstream signal from the received content file. The stream receiving unit 133 includes, for example, a buffer, a demultiplexer, and a decryptor (not shown). The stream receiving unit 133 separates a video bitstream signal, an audio bitstream signal, metadata containing program information, and the like, from the content file received through the interface unit 141. If the separated video bitstream signal has been encrypted, the stream receiving unit 133 decrypts it. From stream receiving unit 133, the video bitstream signal is supplied to the decoder 134, the audio bitstream signal is output to an audio processing unit, (not shown), and the metadata is supplied to the client control unit 140. If the demultiplexer cannot separate the content file, the stream receiving unit 133 notifies the client control unit 140. The client control unit 140 then notifies the user, by displaying a notification on the display unit 137, for example, that the content cannot be received normally. The stream receiving unit 133 may also receive a signal that a demodulator, not shown, generates by demodulating a broadcast signal received by an antenna or tuner (not shown).

The decoder 134 generates a moving picture image signal by decoding the video bitstream signal received from the stream receiving unit 133. For example, under control of the client control unit 140, the decoder 134 receives the video bitstream signal and generates a moving picture image signal by decoding the video bitstream signal, and outputs the image signal to the video buffer 135. If the video bitstream signal has not been encoded, the decoder 134 notifies the client control unit 140. The client control unit 140 then notifies the user that normal decoding cannot be performed, by displaying a notification on the display unit 137, for example. If the video bitstream signal has not been encoded in a format supported by the decoder 134, if the decoding capability of the decoder 134 is exceeded, and in various other cases, the decoder 134 cannot decode the input video bitstream signal.

The video buffer 135 holds the moving picture image signal received from the decoder 134 temporarily. The video buffer 135 holds the image signal of a single image, for example, and outputs the image signal to the image coordination unit 136.

The image coordination unit 136 generates screen image data of the screen image to be displayed on the display unit 137 by coordinating the image in the video buffer 135 and the image in the graphics buffer 132, and outputs the screen image data to the display unit 137. In general the image coordination unit 136 may generate the screen image data by, for example, overlaying the image of the image signal stored in the graphics buffer 132 on the image of the image signal stored in the video buffer 135, or by blending the images with a given transparency ratio. When the image signal representing the desktop image of the server device 110 is stored in the graphics buffer 132, the image coordination unit 136 generates screen image data for displaying the image of the image signal stored in the graphics buffer 132 in the foreground with a transparency ratio of 0%. When the user has selected a content file and the video buffer 135 holds a moving picture image signal, the image coordination unit 136 may erase the image of the image signal stored in the graphics buffer 132 and generate screen image data for displaying just the image of the image signal stored in the video buffer 135.

In the display control unit 142, if the image signal representing the desktop image is received from the remote client unit 131, the desktop image is displayed on the screen of the display unit 137. If an image signal of a content file (moving picture file) is received from the decoder 134, the content file image (moving picture) is displayed on the display unit 137.

The display unit 137 displays the image data received from the image coordination unit 136 as a picture or image. The display unit 137 is implemented as, for example, a display having a screen. The display may be a liquid crystal display having a liquid crystal panel, an organic light emitting diode (OLED) or organic electroluminescence (EL) display device, or another type of display device.

The input unit 138 receives input of user operations. The input unit 138 may be implemented as an input device such as a keyboard, a mouse, or a touch panel. While the remote client unit 131 is performing remote control of the server device 110, the remote server unit 111 updates the image signal representing the desktop image stored in the graphics buffer 112 in accordance with operations performed on the input unit 138. The user of the client device 130 can select a content file stored in the content storage unit 113 and execute desired processing through the remote client unit 131 by operating the input unit 138.

The event detection unit 139 monitors user operations input to the input unit 138. When it detects a predetermined operation, the event detection unit 139 notifies the client control unit 140. The predetermined operation may be a double click on a mouse or a combination of a single click on a mouse and the pressing of the Enter key on the keyboard.

The client control unit 140 controls all processing in the client device 130. When the event detection unit 139 notifies the client control unit 140 of the detection of an event, the client control unit 140 sends a file request through the interface unit 141 to the server control unit 116. The client control unit 140 then has the stream receiving unit 133 separate a video bitstream signal from the received content file, has the decoder 134 decode the signal, and has the video buffer 135 store the decoded image signal. If decoding succeeds, the client control unit 140 controls the image coordination unit 136 to switch the image displayed on the display unit 137 from the image based on the image signal stored in the graphics buffer 132 to an image based on the image signal stored in the video buffer 135. If the stream receiving unit 133 or decoder 134 notifies the client control unit 140 of a processing failure, the client control unit 140 controls the image coordination unit 136 so as to have the image based on the image signal stored in the graphics buffer 132 displayed continuously on the display unit 137.

The interface unit 141 is connected to the network 150 and functions as a first interface for sending and receiving data.

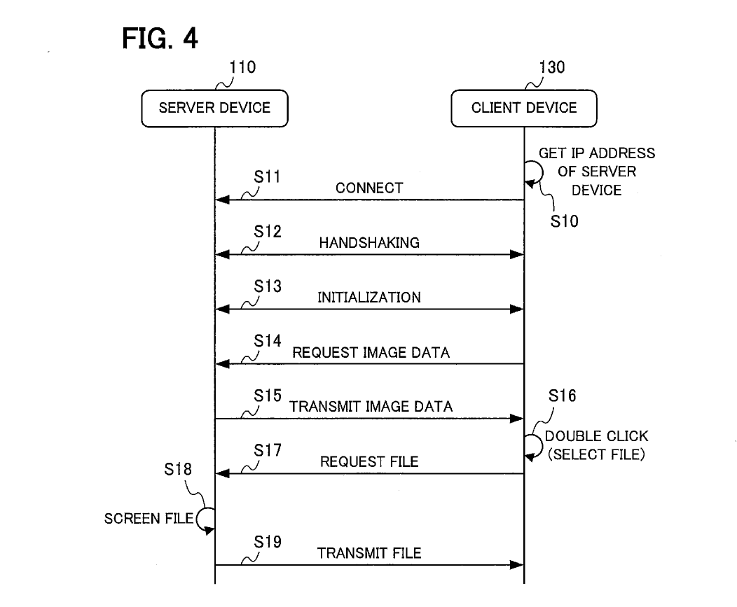

The remote operation and content file transmission sequence will now be described with reference to FIG. 4. In advance of this sequence, the user of the remote control system 100 first starts the remote server unit 111 in the server device 110 and then starts the remote client unit 131 in the client device 130.

In step S10, the remote client unit 131 receives the communication address (e.g., IP address) of the server device 110 by input from the user of the remote control system 100 through the input unit 138. In step S11, the remote client unit 131 uses the communication address input in step S10 to connect with the server device 110 through the interface unit 141.

In step S12, the remote server unit 111 and remote client unit 131 perform handshaking to agree on a protocol version, a security type, and so on. In step S13, the remote server unit 111 and remote client unit 131 exchange initialization messages in which, for example, the size of the graphics buffer 112 in the server device 110 is reported.

In step S14, the remote client unit 131 asks the server device 110 for the image signal of its desktop image. In step S15, the remote server unit 111 sends the image signal representing the desktop image stored in graphics buffer 112.

The server's desktop image is thereby displayed on the display unit 137 at the client device 130, by VNC, and the user can operate the server device 110 remotely through the input unit 138 at the client device 130. VNC processes performed by the remote client unit 131 and remote server unit 111 after step S15 are omitted from the sequence shown in FIG. 4.

Using the desktop image of the server device 110 displayed on the display unit 137, in step S16 the user performs an operation such as a double-click, for example, on the input unit 138 to select a content file stored in the content storage unit 113.

The event detection unit 139 detects the selection operation performed on the input unit 138 and notifies the client control unit 140. Using the communication address input in step S10, the client control unit 140 sends a file request through the interface unit 141 to the server device 110 in step S17. Here the client control unit 140 preferably uses a communication protocol differing from the communication protocol used by the remote client unit 131. For example, the client control unit 140 may communicate with the server control unit 116 by using a special IP protocol or some other known protocol, such as RS-232 over IP.

Receiving the file request through the interface unit 117, the server control unit 116 has the file filter 114 inspect and screen the user-selected content file in step S18. In a part of the process not shown in the drawings, the remote server unit 111 receives event information corresponding to the selection operation made in step S16 through the interface unit 117. According to the event information received by the remote server unit 111, the server control unit 116 accesses the content file stored in the content storage unit 113 and gives the file filter 114 an inspection command including information about the content file to be accessed. The file filter 114 inspects and screens the content file specified by the command. Since the screen update speed in remote operation depends on the image size, the file filter 114 checks whether the selected content file has an image size equal to or greater than a predetermined size.

If the screening conditions are satisfied, then in step S19, the stream server unit 115 sends the content file through the interface unit 117 to the stream receiving unit 133 of the client device 130.

In the sequence shown in FIG. 4, the remote server unit 111 starts up first, and then the remote client unit 131 is connected to the remote server unit 111, but this order of operations may be reversed. The remote client unit 131 may start up first, a communication address may then be set in the remote server unit 111, and the remote server unit 111 may proceed to connect to the remote client unit 131. The remote server unit 111 and the remote client unit 131 may also exchange other information, not mentioned above.

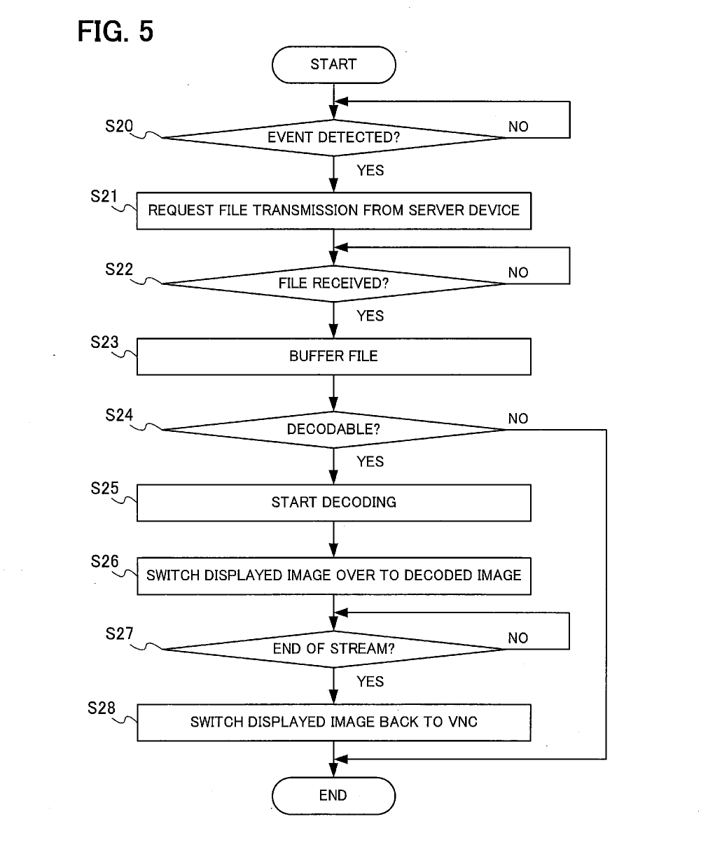

The operation of the client control unit 140 for switching the image displayed on the display unit 137 will be described with reference to FIG. 5.

In step S20, the client control unit 140 determines whether an operation such as a double-click event to select a content file has been input to the input unit 138. When such an event occurs (Yes in step S20), the client control unit 140 proceeds to step S21 and sends a file request through the interface unit 141 to the server control unit 116.

In step S22, the client control unit 140 determines whether the content file has been received through the interface unit 141. When the content file has been received (Yes in step S22), the client control unit 140 proceeds to step S23. If the reception of the content file cannot be confirmed for a given period of time, if the content file selected by the file filter 114 turns out not to be a moving picture file and the server control unit 116 cancels file transmission, and in various other cases, the client control unit 140 may abort the processing and end the process shown in FIG. 5 at this point.

In step S23, the client control unit 140 has the stream receiving unit 133 hold the video bitstream signal temporarily. In step S24, the client control unit 140 lets the stream receiving unit 133 output the video bitstream signal to the decoder 134 and determines whether the decoder 134 can decode the video bitstream signal. If the signal can be decoded (Yes in step S24), the client control unit 140 proceeds to step S25. If the signal cannot be decoded (No in step S24), the process ends.

In step S25, the client control unit 140 has the decoder 134 start decoding.

In step S26, the client control unit 140 controls the image coordination unit 136 so that it generates screen image data according to the decoded image signal stored in the video buffer 135. The generated screen image data are supplied to the display unit 137, which displays a picture based on the screen image data. The picture displayed on the display unit 137 is thereby switched over to the moving picture in the content file.

In step S27, the client control unit 140 determines whether the decoding of the content file has ended. When decoding has ended (Yes in step S27), the client control unit 140 proceeds to step S28. In step S28, the client control unit 140 controls the image coordination unit 136 so that it generates screen image data in accordance with the image signal stored in the graphics buffer 132. Accordingly, the screen of the display unit 137 is switched back from the moving picture reproduced in the video buffer 135 to the desktop image of the server device 110 (the normal VNC image) reproduced in the graphics buffer 132.

The first embodiment has the following effects (1) to (3).

(1) The user can use the server's desktop image, which is displayed at the client device, to select moving picture content files intuitively by remote control, not requiring a special user interface. The display at the client device 130 can then be switched over from the server's desktop image to the moving picture image, and the selected moving picture can be displayed by use of the server and client streaming facilities, so that the user can view the moving picture without being troubled by slow screen update speed and hear its accompanying audio.

(2) The file filter 114 screens out unnecessary files such as document files, and the server device 110 streams only moving picture files having an image size equal to or greater than a predetermined size to the client device 130. Since the display on the screen of the display device 137 is switched only when a moving picture file satisfying the size condition is selected, the switching frequency is reduced, and a more appropriate screen display can be obtained.

(3) In the client device 130, the stream receiving unit 133 obtains the input stream, and the decoder 134 decodes it to reproduce the moving picture. If the input stream cannot be decoded, this process is halted, so an incorrect image is not displayed.

### Second Embodiment

Referring again to FIG. 1, the remote control system 200 in the second embodiment includes a server device 210 and a client device 230.

Referring to FIG. 2, the server device 210 includes a remote server unit 111, a graphics buffer 112, a content storage unit 113, a file filter 214, a stream server unit 115, a server control unit 216, and an interface unit 117. The server device 210 in the second embodiment differs from the server device 110 in the first embodiment in regard to the processing in the file filter 214 and server control unit 216. The file filter 214, stream server unit 115, and server control unit 216 form a processing unit 218.

The server control unit 216 performs the same processing as described in the first embodiment and in addition receives notification of an allowable image size from the client device 230 through the interface unit 117. The server control unit 216 then sets this allowable image size in the file filter 214.

The file filter 214 performs the processing described in the first embodiment, but supplies a user-selected content file to the stream server unit 115 if the content file is a moving picture file and has an image size equal to or greater than the allowable image size set by the server control unit 216.

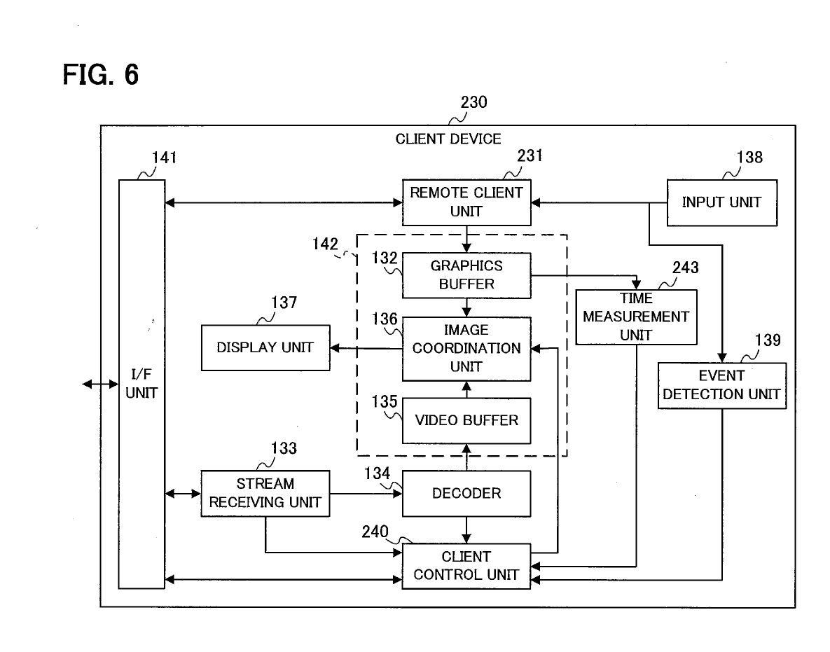

Referring to FIG. 6, the client device 230 includes a remote client unit 231, a graphics buffer 132, a stream receiving unit 133, a decoder 134, a video buffer 135, an image coordination unit 136, a display unit 137, an input unit 138, an event detection unit 139, a client control unit 240, an interface unit 141, and a time measurement unit 243. The client device 230 differs from the client device 130 in the first embodiment in regard to the processing performed in the remote client unit 231 and client control unit 240 and in that it also includes the time measurement unit 243.

The remote client unit 231 performs the processing described in the first embodiment and in addition, suspends remote control of the server device 210 when given a suspension command by the client control unit 240. The remote client unit 231 resumes remote control of the server device 210 when given a resume command by the client control unit 240. Remote control includes the transmission of event information to the server device 210 and the reception of the image signal representing the desktop image from the server device 210. Accordingly, the remote client unit 231 can suspend remote control by suspending either event transmission or desktop image signal reception, or both.

When the user remotely controls the server device 210 through the remote client unit 231, the time measurement unit 243 measures the image signal transfer time from the server device 210. For example, the time measurement unit 243 may measure the time that elapses from an image signal request made by the remote client unit 231 to the server device 210 through the interface unit 141 until a single frame of the requested image signal has been stored in the graphics buffer 132. The time measurement unit 243 is not limited to measuring the transfer time of a single frame, however; the measurement may be based on other signal quantities as appropriate. The time measurement unit 243 supplies the measured transfer time to the client control unit 240.

The client control unit 240 determines the allowable image size in accordance with the transfer time supplied from the time measurement unit 243. For example, the client control unit 240 may reduce the allowable image size as the transfer time increases. It is not necessary, however, for the allowable image size to be proportional to the transfer time; any appropriate relationship between the allowable image size and the transfer time may be selected. The client control unit 240 notifies the server control unit 216 of the allowable image size through the interface unit 141.

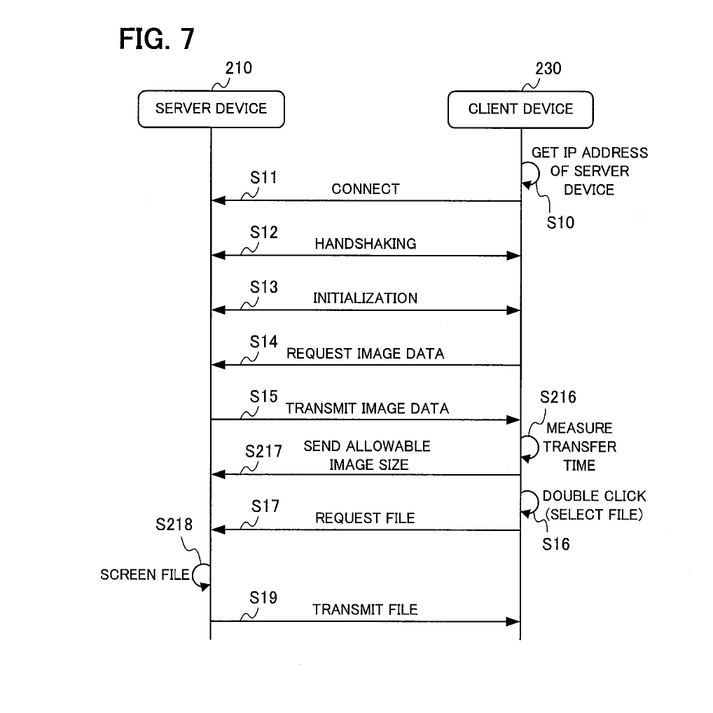

The remote operation and content file transmission sequence will now be described with reference to FIG. 7. Steps S11 to S15 are the same as steps S11 to S15 in FIG. 4.

When remote control starts, the client device 230 does not have the image signal representing the desktop image, so the client device 230 requests this image signal in step S14, and the server device 210 sends it in its entirety as a single frame in step S15. The remote client unit 231 receives the image signal through the interface unit 141 and stores it in the graphics buffer 132.

In step S216, the time measurement unit 243 measures the transfer time that elapses from the time when the remote client unit 131 sends the image data request in step S14 until the time when the graphics buffer 132 has acquired the entire desktop image signal in step S15. The time measurement unit 243 supplies the measured transfer time to the client control unit 240.

The client control unit 240 then determines the allowable image size from the received transfer time. In step S217, the client control unit 240 notifies the server device 210 of the determined allowable image size by sending size information through the interface unit 141. The server control unit 216 receives the notification through the interface unit 117 and sets the allowable image size in the file filter 214.

In step S16, the user performs an operation such as a double-click, for example, on the input unit 138 to select a content file. The event detection unit 139 detects the selection operation on the input unit 138 and notifies the client control unit 240. In step S17, the client control unit 240 sends a file request to the server device 210 through the interface unit 141.

Upon receiving the file request through the interface unit 117, the server control unit 216 has the file filter 114 inspect and screen the user-selected content file in step S218. The file filter 214 checks whether the selected content file has an image size equal to or greater than the allowable image size specified by the server control unit 216.

If the selected content file is a moving picture file and if the content file has an image size equal to or greater than the allowable image size, the server control unit 216 has the stream server unit 115 send the content file to the stream receiving unit 133 in step S19.

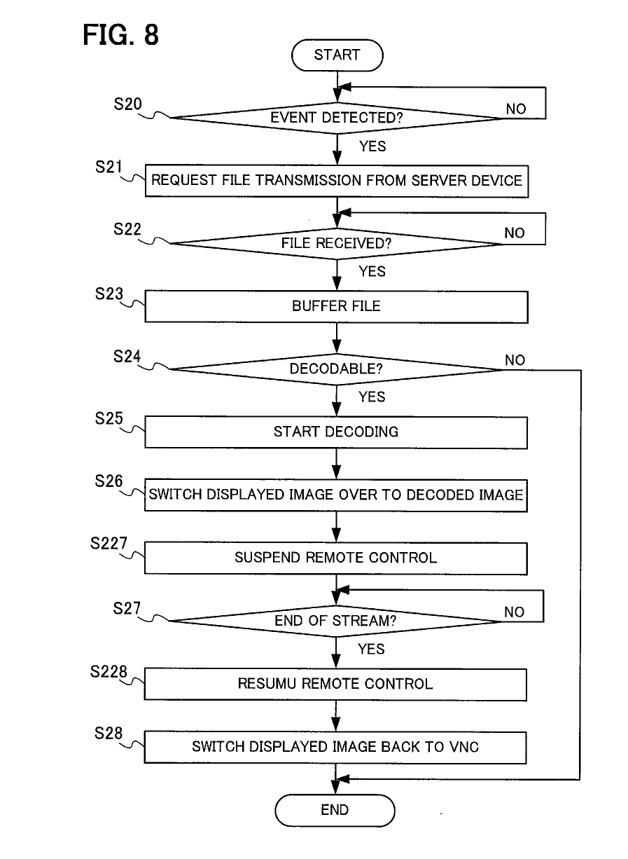

A further example of the operation of the second embodiment will be described with reference to FIG. 8. Steps S20 to S26 are the same as steps S20 to S26 in FIG. 5, except that in step S26, when the image displayed on the screen of the display unit 137 is switched over to the moving picture in the content file, the client control unit 240 gives the remote client unit 231 a suspension command.

Upon receiving the suspension command, in step S227 the remote client unit 231 disconnects communication with the remote server unit 111 through the interface unit 141 and suspends remote control, without breaking communication between the stream receiving unit 133 and the stream server unit 115. That is, the communication link for remote control is disconnected but the communication link for transmission of the content file (moving picture file) is maintained.

In step S27, the client control unit 240 determines whether the content file input stream has ended. When the input stream has ended (Yes in step S27), the client control unit 240 proceeds to step S228.

In step S228, the client control unit 240 gives the remote client unit 231 a resume command. Upon receiving the resume command, the remote client unit 231 resumes communication with the remote server unit 111 through the interface unit 141 and resumes remote control.

The client control unit 240 next controls the image coordination unit 136 to generate screen image data in accordance with the image signal stored in the graphics buffer 132. The image displayed on the screen of the display unit 137 is switched from the moving picture reproduced in the video buffer 135 to the desktop image of the image signal stored in the graphics buffer 132.

The second embodiment has the following effects (4) to (6) in addition to the effects of the first embodiment.

(4) In the client device 230, the actual time required to transmit image data is measured, and an allowable image size such that the image can be drawn in the graphics buffer without noticeably affecting the screen update speed in remote operation is determined. Therefore, the frequency of screen image switching is reduced, and a more appropriate screen display can be obtained.

(5) Since the actual time required to transmit and produce image data is measured, the client device 230 can be used with a variety of server devices 210.

(6) While the moving picture stream is being transmitted, decoded, and displayed on the display unit 137, image transmission for remote operation is temporarily suspended, thereby reducing the processing load, so the moving picture stream can be transmitted, decoded, and displayed smoothly.

In the description given above, the time measurement unit 243 measures the image transfer time when remote operation starts, but this measurement may also be made at other appropriate times while remote operation is in progress.

In the description given above, remote operation image transmission is suspended by controlling the remote client unit 231 so as to disconnect the communication link with the remote server unit 111, but the communication link may be maintained and the remote client unit 231 may stop sending screen update requests (event information) to the remote server unit 111.

In the first and second embodiments, the functions of the server devices 110, 210 and client devices 130, 230 may be implemented purely by hardware resources such as electronic circuits, or by a combination of hardware and software resources. When hardware and software resources are used in combination, the functions of the server devices 110, 210 and the client devices 130, 230 may be implemented by, for example, a computing device executing a control program. More specifically, the functions of the server and client devices 110, 130, 210, 230 may be implemented when a control program recorded on a recording medium such as a read only memory (ROM) is read into a main memory and executed by a central processing unit (CPU). The control program may be recorded on a computer-readable recording medium such as an optical disc, or may be provided through a communication link or network such as the Internet.

In the example described above, a television receiver (a TV set) is used as the client device, and a computer is used as the server. If a television receiver including a storage unit such as a hard disc drive (HDD) and a player unit for DVDs, media cards, and the like is used, however, the TV set may be used as the server device, and a computer, or a mobile information device such as a portable phone may be used as a client device to view moving picture content stored in the HDD, DVD, or media card in the TV set. Alternatively, a video recorder-player having an HDD or other recording media may be use as the server device, and a computer, portable device, or the like may be used as the client device.

Those skilled in the art will recognize that further variations are possible within the scope of the invention, which is defined in the appended claims.

What is claimed is:

1. A remote control system including a client device and a server device, wherein:
the client device comprises
a first interface unit connected to a network,
an input unit for input of user operations,
a display unit for displaying an image on a screen,
a remote client unit for receiving an image signal representing an operation screen of the server device from the server device through the first interface unit and sending the server device operation information indicating input operations performed on the input unit pursuant to display of the operation screen of the server device on the display unit,
an event detection unit for detecting performance of a predetermined input operation on the input unit,
a client control unit for sending the server device a predetermined notification through the first interface unit when the event detection unit detects the performance of the predetermined operation,
a stream receiving unit for separating a video bitstream signal from a content file received from the server device through the first interface unit,
a decoder for decoding the video bitstream signal to generate an image signal representing a moving picture, and
a display control unit for receiving the image signal representing the operation screen from the remote client unit and causing the display unit to display the operation screen, and for receiving the image signal representing the moving picture from the decoder and causing the display unit to display the moving picture in place of the operation screen; and
the server device comprises
a second interface unit connected to the network,
a remote server unit for receiving the operation information through the second interface unit and sending the client device, through the second interface unit, an image signal representing an operation screen indicating a result of processing performed by the server device in response to the operation indicated by the operation information,
a content storage unit for storing one or more content files, and
a processing unit for receiving the predetermined notification through the second interface unit and thereupon, when the predetermined operation selects one of the content files stored in the content storage unit and the selected content file is a moving picture content file, sending the content file through the second interface unit to the client device.

2. The remote control system of claim 1, wherein the processing unit sends the selected content file to the client device only when the selected content file has an image size equal to or greater than a predetermined image size.

3. The remote control system of claim 1, wherein the client device further comprises a time measurement unit for measuring a transfer time of the image signal representing the operation screen from the server device, the client control unit determines an allowable image size from the transfer time and sends the allowable image size through the first interface unit to the server device, and the processing unit sends the selected content file to the client device only when the selected content file has an image size equal to or greater than the allowable image size.

4. The remote control system of claim 1, wherein when the display control unit causes the display unit to display the screen of the moving picture in place of the operation screen, the client control unit suspends at least one of two processes, the two processes being a process for receiving the image signal representing the operation screen from the server device and a process for sending the operation information to the server device.

5. A client device comprising:
an interface unit connected to a network;
an input unit for input of user operations;
a display unit for displaying an image on a screen;
a remote client unit for receiving an image signal representing an operation screen of a server device on the network from the server device through the interface unit, and sending the server device operation information indicating input operations performed on the input unit pursuant to display of the operation screen of the server device on the display unit;
an event detection unit for detecting performance of a predetermined operation on the input unit;
a client control unit for sending the server device a predetermined notification through the interface unit when the event detection unit detects the performance of the predetermined operation;
a stream receiving unit for separating a video bitstream signal from a content file received from the server device through the interface unit;
a decoder for decoding the video bitstream signal to generate an image signal of a moving picture; and
a display control unit for receiving the image signal representing the operation screen from the remote client unit and causing the display unit to display the operation screen, and for receiving the image signal of the moving picture from the decoder and causing the display unit to display the moving picture in place of the operation screen.

6. The client device of claim 5, further comprising a time measurement unit for measuring a transfer time of the image signal representing the operation screen from the server device, wherein the client control unit determines an allowable image size from the transfer time and sends the allowable image size through the first interface unit to the server device, and the processing unit sends the selected content file to the client device only when the selected content file has an image size equal to or greater than the allowable image size.

7. The client device of claim 5, wherein when the display control unit causes the display unit to display the screen of the moving picture in place of the operation screen, the client control unit suspends at least one of two processes, the two processes being a process for receiving the image signal representing the operation screen from the server device and a process for sending the operation information to the server device.

8. A server device comprising:
an interface unit connected to a network;
a remote server unit for sending a client device on the network, through the interface unit, an image signal representing an operation screen of the server device, receiving, through the interface unit, operation information indicating an input operation performed at the client device in response to the operation screen, and sending the client device, through the interface unit, an image signal representing an operation screen indicating a result of processing performed by the server device in response to the operation indicated by the operation information;
a content storage unit for storing one or more content files; and
a processing unit for receiving a predetermined notification from the client device through the interface unit and thereupon, when the predetermined operation selects a content file stored in the content storage unit and the selected content file is a moving picture content file, sending the content file through the interface unit to the client device.

9. The server device of claim 8, wherein the processing unit sends the selected content file to the client device only when the selected content file has an image size equal to or greater than a predetermined image size.

10. The server device of claim 8, wherein the processing unit receives an allowable image size from the client device through the interface unit, and sends the selected content file to the client device only when the selected content file has an image size equal to or greater than the allowable image size.
